(19) United States
(12) Patent Application Publication
(10) Pub. No.: US 2019/0147480 A1
(43) Pub. Date: May 16, 2019

(54) MOBILE PHONE WITH ADVERTISING PLATFORM AND METHOD OF USE

(71) Applicant: Shamim Mohammad Naem, Fort Worth, TX (US)

(72) Inventor: Shamim Mohammad Naem, Fort Worth, TX (US)

(21) Appl. No.: 16/192,275

(22) Filed: Nov. 15, 2018

Related U.S. Application Data
(60) Provisional application No. 62/586,360, filed on Nov. 15, 2017.

(51) Int. Cl. G06Q 30/02

(52) U.S. Cl. CPC G06Q 30/0233; G06Q 30/0277; G06Q 30/0239; G06Q 30/0267

(57) ABSTRACT

An advertisement system includes a server having a database; a mobile phone having an exterior case and a display screen; an advertisement platform incorporated into the mobile phone, the advertisement platform in communication with the server to receive an advertisement to be displayed on the display screen, the advertisement platform in communication with a reward system; the reward system to collect point data associated with a user's interaction with the advertisement; the point data collected through the reward system can be redeemed for a reward through the advertisement platform.

### BACKGROUND

### 1. Field of the Invention

The present invention relates generally to mobile phone systems, and more specifically, to a mobile phone system with an advertisement platform for generating reward points.

### 2. Description of Related Art

Mobile phone systems are well known in the art and are effective means of communication, internet usage, and entertainment. For example, FIG. 1 depicts a flowchart of a conventional mobile phone system 101, wherein the user purchases a mobile phone and proceeds to use the phone for communication and/or entertainment, as shown with boxes 103, 105. The user then proceeds to pay a monthly phone bill for the usage of the mobile phone, as shown with box 107.

One of the problems commonly associated with conventional mobile phones is the lack of monetary benefit from usage of the phone. For example, the user has no way or receiving a reward for the constant use of the phone.

Accordingly, although great strides have been made in the area of mobile phone systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common mobile phone system;

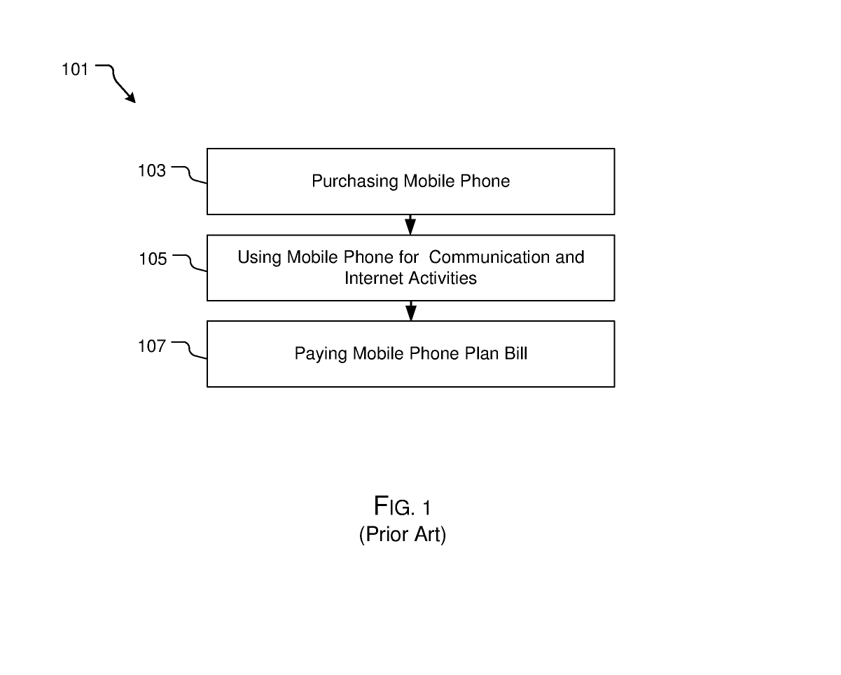

FIG. 2 is a simplified schematic of a mobile phone with an advertisement platform in accordance with a preferred embodiment of the present application;

FIG. 3 is a simplified schematic of the features of the mobile phone and advertisement platform of FIG. 2;

FIG. 4 is a simplified front and back view of the mobile phone of FIG. 2; and

FIG. 5 is a flowchart of the method of use of the mobile phone and advertisement platform of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional mobile phones. Specifically, the present invention provides a means for users to receive reward points for their usage of a mobile phone, wherein the reward points can be redeemed for something of value. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

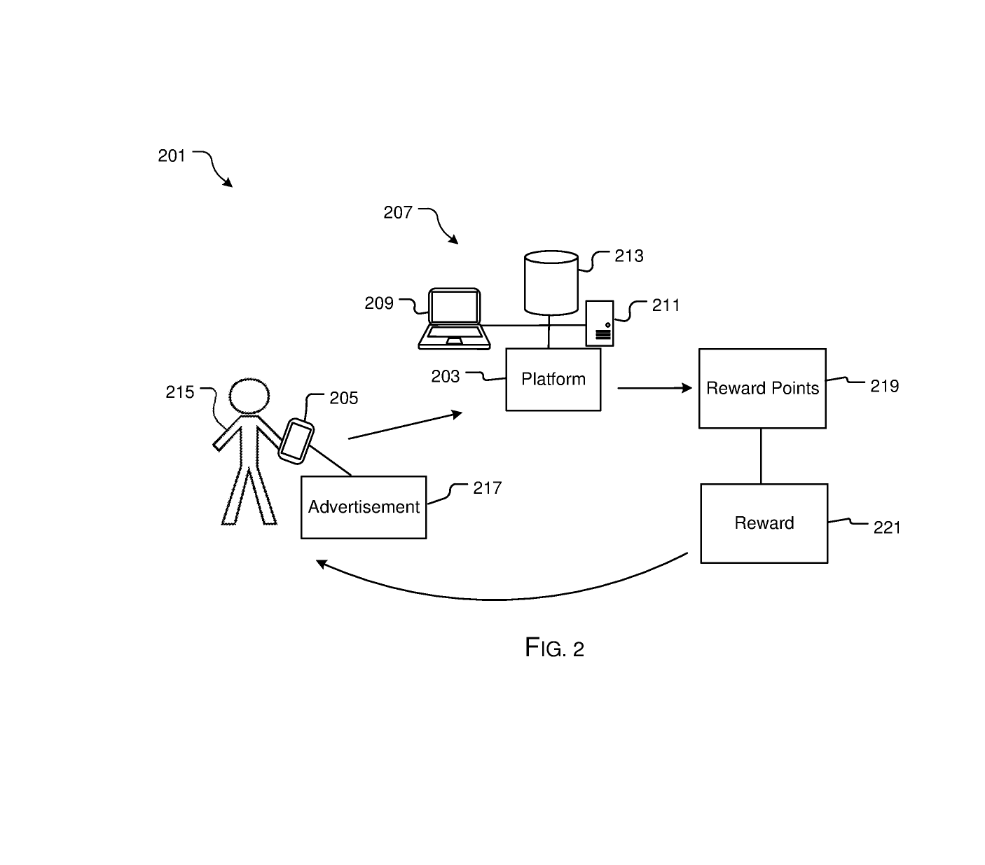

Referring now to the drawings wherein like reference characters identify corresponding or similar elements throughout the several views, FIG. 2 depicts a simplified schematic of a mobile phone system 201 with an advertisement platform 203 in accordance with a preferred embodiment of the present application. It will be appreciated that system 201 overcomes one or more of the above-listed problems commonly associated with conventional mobile phones.

In the contemplated embodiment, system 201 includes a mobile phone 205 having the platform 203 downloaded thereon, wherein platform 203 is configured to communicate with a network 207 having one or more of a computer 209, a server 211, and a database 213.

In the preferred embodiment, platform 203 is configured to present a user 215 with an advertisement 217 displayed on phone 205. Based on the user's interaction with advertisement 217, platform 203 tracks and stores data in the form of reward points 219, wherein the reward points 219 can be redeemed for a reward 221 by user 215.

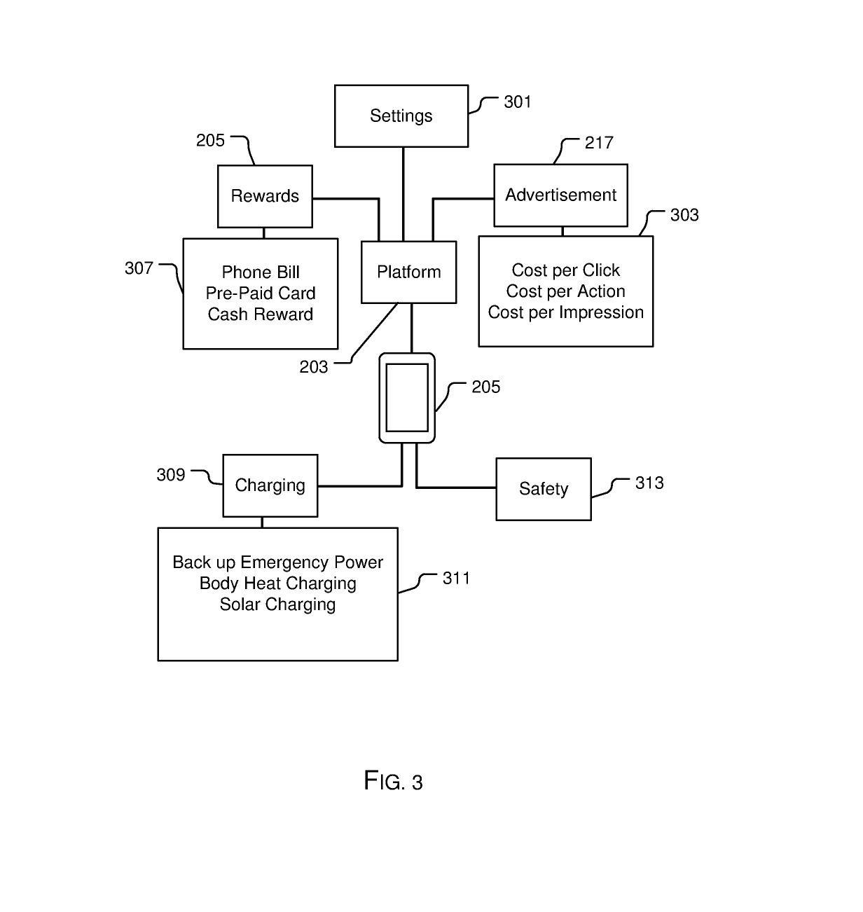

In FIG. 3, a schematic further demonstrates the features of mobile phone 205 and platform 203. Platform 203 includes a settings portal 301, wherein the user can determine when and where the advertisement 217 will be displayed. For example, the user can select for the advertisement to be displayed on a lock screen of the phone, within a text messaging interface of the phone, or on the home screen of the phone. In addition, the settings portal 301 can receive user data such as gender, age, interests, and location, thereby allowing for customized advertisements.

In the preferred embodiment, settings associated with the advertisement 217 can vary. For example, three categories 303 of advertisements could be included, such as a cost per click category, wherein the user will earn points for each click on the advertisement; a cost per action category, wherein the user will earn points for each download; and a cost per impression, wherein no action is needed for the user to receive points.

It should be appreciated that the user can select between various rewards 221. For example, some contemplated rewards 307 include a phone bill selection, wherein the reward points automatically pay for the phone usage; a pre-paid card selection, wherein the user receives a pre-paid card, such as a gas card or gift card; and a cash reward, wherein the user can redeem the points for a cash value.

It should be appreciated that one of the unique features believed characteristic of the present application is the inclusion of the advertisement platform 203 on phone 205, wherein one or more physical rewards are earned. It should be appreciated that this feature allows for the user to pay their phone bill, or receive other rewards, based the user's interaction with the advertisement.

It is contemplated that phone 205 can include additional features. In one embodiment, phone 205 includes a unique charging/power system 309, wherein phone 205 can have multiple power sources 311. Some such power sources include a backup emergency power source that is configured to be activated when the primary power source dies and further only provides power for emergency functions, such as dialing 911 and providing location tracking. It is contemplated that phone 205 can include a power source configured to be charge via body heat or movement, thereby providing an efficient means to receive power. Further, phone 205 can include a solar charging feature.

In some embodiments, phone 205 further includes additional safety features 313, specifically for parents. One contemplated safety feature is a parent monitoring system, wherein the parent receives notices regarding the location of a child and/or a speed of driving associated with the child. It should be appreciated that this information can be determined via a GPS system of phone 205, wherein this information is further transmitted to a second phone or computing device associated with the parent. In addition, phone 205 can include a locking and unlocking function wherein a parent can set a master password of phone 205 to then have the ability to lock and unlock various features and aspects of phone 205. Further, phone 205 can be password protected, wherein phone 205 is programmed to provide an alert to a second phone or computing device upon receiving a pre-determined number of incorrect password attempts, this allows for additional parental monitoring.

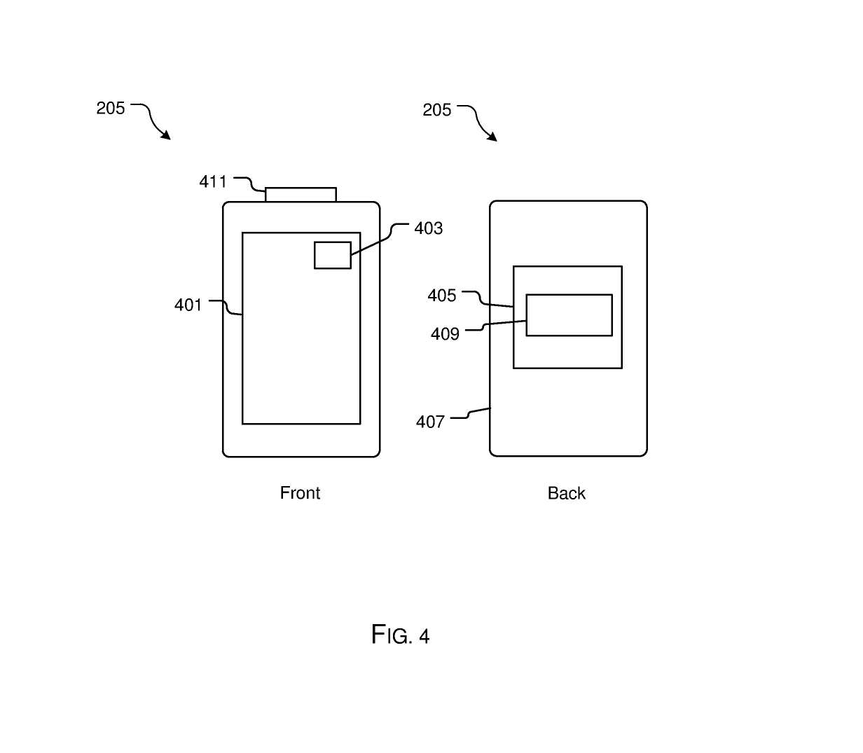

In FIG. 4, a front and back simplified views of phone 205 are shown. In one embodiment, phone 205 includes a front display 401 wherein an advertisement 403 can be displayed. In addition, it is contemplated that a back display 405 can be incorporated into a case 407 of the mobile phone, thereby allowing for an advertisement 409 to be displayed therein. In addition, phone 205 can include a projector 411 configured to project an image from the phone 205. It should be appreciated that phone 205 can include additional features such as charging ports, adapters, cases, and other various components.

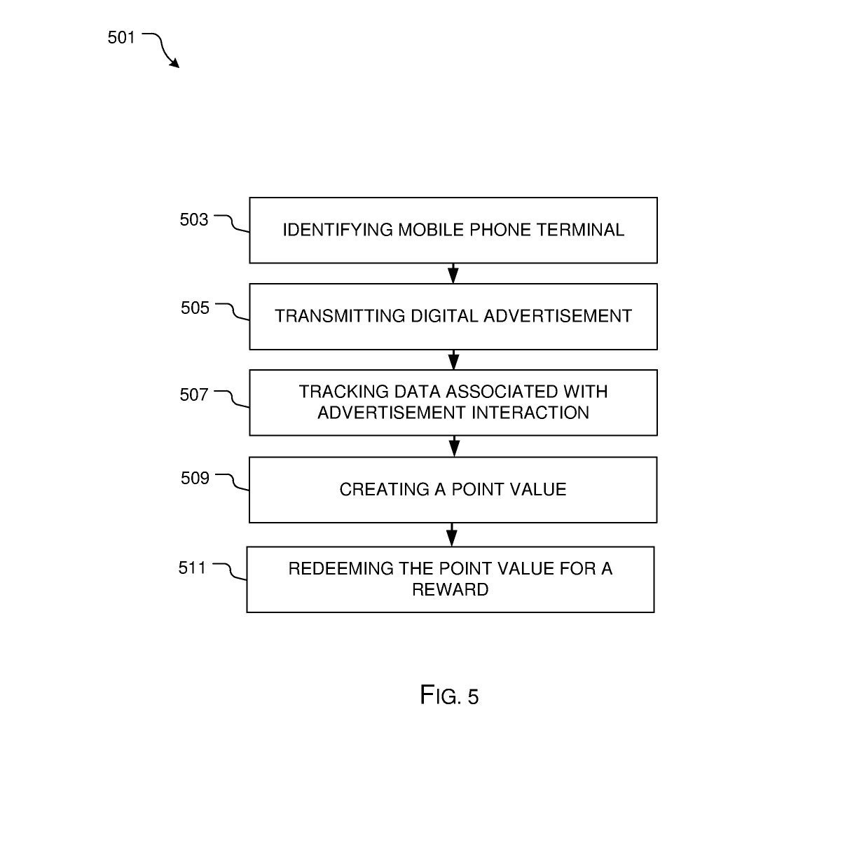

In FIG. 5, a flowchart 501 depicts the method of use of system 201. During use, a phone terminal is identified, wherein an advertisement is transmitted to be displayed on one or more screens of the phone, as shown with boxes 503, 505. The advertisement platform is configured to track user interaction with the advertisement, such as passive interaction, clicking data, downloading data, or other data, as shown with box 507. This data is translated into point values to be redeemed for a reward, as shown with boxes 509, 511.

It should be appreciated that platform 203 can be a mobile application configured to be downloaded on any mobile phone, or alternatively, platform 203 can be software and/or hardware integrally incorporated into the phone.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An advertisement system, comprising:
a server having a database;
a mobile phone having an exterior case and a display screen;
an advertisement platform incorporated into the mobile phone, the advertisement platform in communication with the server to receive an advertisement to be displayed on the display screen, the advertisement platform in communication with a reward system;
the reward system configured to collect point data associated with a user's interaction with the advertisement;
wherein the point data collected through the reward system can be redeemed for a reward through the advertisement platform.

2. The system of claim 1, wherein the reward is a translation of the point data into a monetary value to be credited toward a phone plan account.

3. The system of claim 1, wherein the reward is a translation of the point data into a cash value.

4. The system of claim 1, wherein the reward is a translation of the point data into a pre-paid card value.

5. The system of claim 1, wherein the advertisement platform is configured to display the advertisement within an SMS messaging interface.

6. The system of claim 1, wherein the mobile phone further comprises:
an LED display incorporated into a back of the exterior case;
wherein the advertisement can be displayed on the LED display.

7. A method of providing an advertisement through a mobile phone, the method comprising:
identifying a mobile phone terminal associated with a user;
transmitting a digital advertisement to be displayed on a display screen;
tracking data associated with a user's interaction with the advertisement;
translating the data into a point value; and
redeeming the point value for a reward.

8. The method of claim 7, wherein the reward is monetary value to be credited toward a phone plan account.

9. The method of claim 7, wherein the reward is a cash value.

10. The method of claim 7, wherein the reward is a pre-paid card.
